(19) United States
(12) Patent Application Publication
(10) Pub. No.: US 2015/0058030 A1
(43) Pub. Date: Feb. 26, 2015

(54) METHOD AND APPARATUS FOR RECOMMENDING AN ALTERNATIVE TO A PRESCRIPTION DRUG REQUIRING PRIOR AUTHORIZATION

(71) Applicant: CoverMyMeds, LLC, Columbus, OH (US)

(72) Inventors: Matthew A. Scantland, Upper Arlington, OH (US); Samuel M. Rajan, Hudson, OH (US); Alan J. Gilbert, Sunbury, OH (US); Ryan E. Sanders, Sugarloaf Key, FL (US)

(73) Assignee: CoverMyMeds, LLC, Columbus, OH (US)

(21) Appl. No.: 14/261,521

(22) Filed: Apr. 25, 2014

Related U.S. Application Data
(60) Provisional application No. 61/869,050, filed on Aug. 22, 2013.

(51) Int. Cl. G06F 19/00; G06Q 50/22

(52) U.S. Cl. CPC G06F 19/3456; G06F 19/328; G06Q 40/08; G06Q 50/22
USPC 705/2

(57) ABSTRACT

Provided is a method of processing a request pertaining to a prescription drug. The method includes receiving, with a computer system after a claim requesting at least partial insurance coverage of a cost associated with the prescription drug has been submitted to an insurance benefits manager, a notification that prior authorization has been required. Before the request for prior authorization is submitted, it is determined that an alternate drug is a possible substitute for the prescription drug, and the alternate drug is believed to not require prior authorization under the insurance policy. The determination is made based on data contained in a database that is generally accepted in a pharmacy industry and is not unique to an insurer affiliated with the insurance policy.

### CROSS-REFERENCE TO RELATED APPLICATIONS

This application claims the benefit of U.S. Provisional Application No. 61/869,050, filed Aug. 22, 2013, which is incorporated in its entirety herein by reference.

### BACKGROUND OF THE INVENTION

1. Field of the Invention

This application relates generally to a method and apparatus for fulfilling a prescription and, more specifically, to a method and apparatus for presenting an alternate drug to a prescribed drug that requires prior authorization.

2. Description of Related Art

Traditionally, when a physician prescribes a drug to a patient, that prescription is taken to a pharmacy to be fulfilled. For a prescription drug covered by the patient's health insurance, at least a portion of the prescription drug's cost is paid by the health insurance provider. The recipient of the prescription drug is required to pay any remaining balance not covered by the health insurance provider.

Occasionally, there may be criteria established by an insurance provider establishing when the prior authorization of the insurance provider is required before the prescription drug can be dispensed. For example, the prescription drug may be of a dose not conventionally prescribed to a certain demographic to which the patient belongs. Another example of a drug requiring prior authorization is a prescription drug with a cost that exceeds a threshold amount that the patient's health plan will cover. As yet another example, brand-name drugs for which a generic is available may also require the prior authorization of the insurance provider before any portion of the brand name drugs cost can be covered by the patient's health plan. Under such circumstances, patients have traditionally faced the dilemma of whether to pay for the drug prescribed by a physician out-of-pocket or await a decision from the insurance provider whether to grant prior authorization for the prescribed drug.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows an illustrative embodiment of a computerized system for requesting prior authorization of coverage for at least a portion of the cost of a prescription drug;

FIG. 2 shows a flow diagram schematically illustrating a method of facilitating the presentation of an alternate drug to a user who has initiated a process of requesting prior authorization for a prescription drug prescribed by a physician;

FIG. 3 shows an embodiment of a user interface and window presented to a user, the window presenting the user with an option to proceed with the prior authorization request process for the prescription drug and an option to prepare an ad hoc prescription form for an alternate drug that does not require prior authorization;

FIG. 4 shows an illustrative embodiment of an ad hoc prescription form including a listing that comprises a plurality of alternate drug options;

FIG. 5 shows an illustrative embodiment of an ad hoc prescription form including a single alternate drug selected by a physician licensed to prescribe the alternate drug; and

FIG. 6 shows an illustrative embodiment of a user interface into which a user can enter search criteria for selecting a form to be submitted as part of a request for prior authorization for a prescribed drug.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

Accordingly, there is a need in the art for a method and apparatus for facilitating a request for prior authorization that notifies a user of at least one alternate drug, if available, that does not require prior authorization as a substitute for a prescription drug that does require prior authorization. The one or more alternate drugs that can be offered as a substitute for a prescription drug prescribed by a physician include a generic version of the prescribed drug. Generics are therapeutically the same as their brand-name counterparts, but typically cost much less. Thus, when available, a generic version of the prescribed drug can be brought to the attention of the user as described in detail below.

According to another embodiment, a server 22 such as that described below can access a database of preferred drugs stored on a computer-readable medium. The database of preferred drugs can include a collection of prescription drugs along with one or more preferred alternate drugs that are generally accepted in the pharmacy industry as suitable substitutes for their respective prescription drugs. For example, the preferred alternate drugs included in the database can be generally accepted in the industry as alternate drugs that are commonly dispensed in fulfillment of a prescription without prior authorization from insurance providers. The contents of the database can optionally be ubiquitous, and not unique to a specific insurance provider and/or insurance plan. For example, the generally-accepted alternate drugs in the database can be considered to be suitable substitutes for prescribed drugs across a plurality, and optionally all, insurance providers and/or insurance plans. Thus, in determining that an alternate drug exists and can be proposed as a substitute for a drug prescribed by a physician, the server 22 references the database and utilizes the content thereof to identify a suitable alternate drug to propose independent of the insurance provider and/or insurance plan submitted on behalf of the particular patient.

Specific examples of alternate drugs that are recommendable as substitutes include, but are not limited to, generic versions of the prescription drug prescribed by the physician. It is understood, and generally accepted without first verifying the validity of the assumption separate from a prior authorization request that a generic drug is an alternate drug that can be suitably substituted for a prescription drug without requiring the prior authorization of the insurance benefits manager (e.g., insurance provider, pharmacy benefits manager, or other entity authorized to render a decision regarding coverage of an insurance plan). Thus, in response receiving an indication that prior authorization is required for a prescribed drug, the server 22 can respond by proposing substitution of the generic alternate drug for the prescribed drug before proceeding with the process of preparing and optionally submitting the request for prior authorization. In other words, the process of preparing and optionally submitting the request for prior authorization of the prescription drug can be suspended pending receipt of an indication whether the proposed alternate generic drug has been accepted as a substitute for the prescribed drug.

If the proposed alternate drug is deemed to be acceptable for fulfillment of the prescription, the process of requesting prior authorization for the prescription drug that was originally prescribed can be terminated, without submission of the request for prior authorization to the insurance benefits manager in the first place. If, however, an indication is received by the server 22 indicating that the proposed alternate drug is not acceptable, or that the prescription drug originally prescribed is still desired, the process of requesting prior authorization by transmitting content as part of the request for prior authorization over the communication network to ultimately be submitted to the insurance benefits manager is resumed.

Other examples of alternate drugs suitable as substitutes for their respective prescription drug counterparts include, but are not limited to, alternates proposed for clinical reasons, business reasons, or a combination thereof. For instance, the clinical reason for including an alternate drug in the database is that new drugs are continuously developed over time. Such newly-developed drugs may constitute a more-effective treatment of an ailment or condition than the legacy prescription drug known to, and prescribed by physicians. Perhaps the newly-developed drug is too new to have gained wide acceptance in practice or have been evaluated by insurance providers, so notifying the user of the new drug's existence as a suitable alternative, regardless of the specific insurance provider and/or insurance plan, may improve patient care. Similarly, one or more of the preferred alternate drugs can be included in the database for business or economic reasons. Perhaps the preferred alternate drugs are therapeutically equivalent (or at least therapeutically comparable or useful) to their respective prescription drugs listed in the database, but cost substantially less than the drug actually prescribed (e.g., at least 20% less, at least 30% less, at least 40% less, or at least 50% less, etc. . . . ). When one of those prescription drugs is prescribed and a process of requesting prior authorization through the system described herein is initiated, one or more of the preferred alternate drugs for that prescribed drug can be presented to the user as a suitable substitute.

According to yet other embodiments, there are other instances where an alternate drug can be proposed as a substitute for a prescription drug prescribed by a physician that requires prior authorization. For example, the database mentioned above can include a substantially-up-to-date collection (e.g., updated within a reasonable time from a date on which a decision is rendered by a regulatory body such as the U.S. Food and Drug Administration “FDA”) of drugs that are no longer permitted to be prescribed to patients, possibly within a certain geographic region (e.g., country wide, state by state, etc. . . . ).

The database can also be updated to reflect an availability of one or more prescription drugs. For example, if a manufacturing facility that produces a certain drug is shut down by the FDA or as a result of an accident or shortage of raw materials, the likely result is a shortage or unavailability of that certain drug. Under circumstances where that certain drug is prescribed but is unavailable or available only to patients who most-urgently need that certain drug. The database can reflect such circumstances and an alternate drug, if available in the database for that certain drug, can be proposed as a substitute for the certain drug if that certain drug is prescribed by the physician. As another example, the availability in the pharmacy can also influence the recommendation of an alternate drug as a substitute for a prescribed drug. If the pharmacy fulfilling the prescription is out of tablets with a 20 mg dose of a prescribed drug, but has tablets with a 40 mg dose of the prescribed drug in stock, the 40 mg dose of the drug can be presented as a possible alternate drug along with an instruction to utilize a pill splitter to bisect the 40 mg. pills.

Regardless of the reason behind proposing the alternate drug as a substitute for the prescribed drug, the alternate drugs in the database have not necessarily been independently verified, separate from a transaction during which prior authorization is requested, as being true for inclusion in the database. The database can be populated with data that is believed to be true (e.g., that an alternate associated with a prescribed drug can be suitable substituted for that prescribed drug to avoid the need for prior authorization) across insurance providers and/or insurance plans in an effort to eliminate the need for prior authorization. In other words, general knowledge or beliefs in the pharmacy industry can be reflected in the data of the database, so the database maintenance is simplified, and does not require specific knowledge of acceptable alternate drugs for each and every specific prescription drug for each and every individual insurance provider and/or insurance plan. However, if an alternate drug is proposed, and the prescription is ultimately fulfilled with the proposed alternate drug, the database can optionally be updated to indicate that that alternate drug has previously been used to fulfill a prescription originally prescribing the corresponding prescribed drug. In this manner, the database, or at least a portion of the data in the database, can be considered to have been verified in response to approval by the insurance benefits manager of at least partial insurance coverage of the alternate drug without requiring prior authorization. Data verified in this manner can be considered by the server 22 as being even more likely to be approved by other insurance providers and/or under other insurance policies without the need for prior authorization.

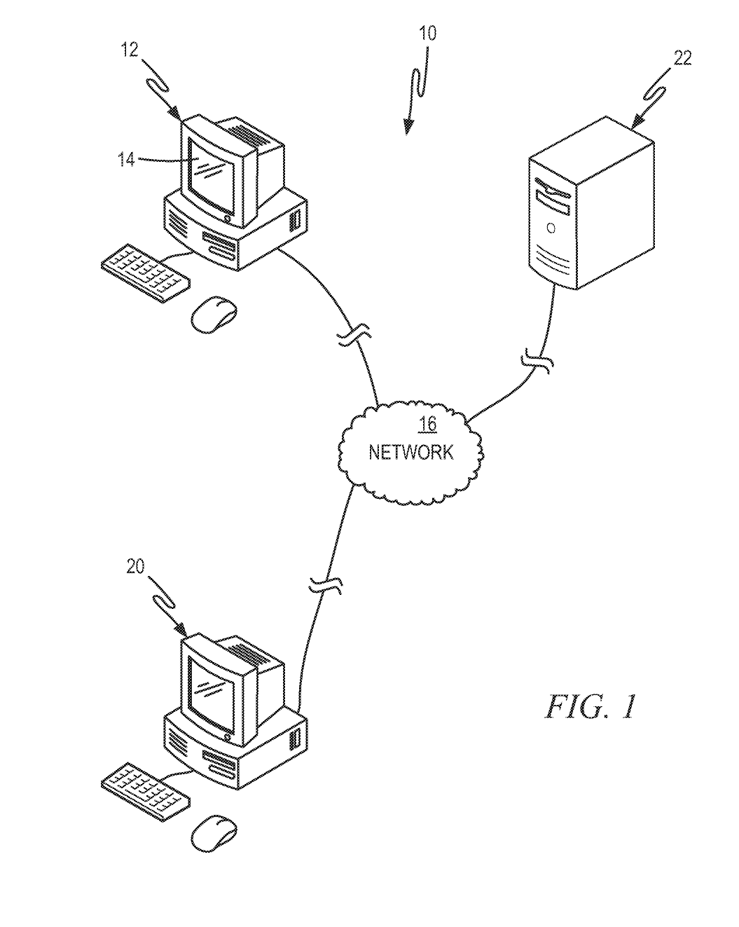

An illustrative embodiment of a distributed computer system 10 that facilitates a method of seeking prior authorization to cover at least a portion of the price of a prescription drug according to an insurance plan or policy is shown in FIG. 1. According to the illustrative embodiment, the system 10 includes a user computer 12 that can be located at a pharmacy, physician's office, or any other location where a user can initiate the process of requesting prior authorization of insurance coverage toward the price of a prescription drug. For the embodiments where the user computer 12 is disposed at a pharmacy where a prescription has been taken to be fulfilled, the user computer 12 can be programmed and otherwise adapted with at least one of a pharmacy-specific application (e.g., configured specifically for distributing, and documenting the distribution of prescription drugs), point-of-sale application, and any other application utilized in fulfilling a prescription.

The user computer can be a general-purpose computer including a non-transitory computer-readable memory, and a monitor 14 that displays various user interfaces including data fields (e.g., free text entry, drop down menus, radio buttons, etc. . . . , and any combination thereof) included in an electronic form in which the user can input data to be submitted as part of the request for prior authorization. A computer processor provided to the user computer 12 can be programmed with computer-executable instructions stored in the memory to generate the user interfaces presented by the monitor 14, receive the user-input information and transmit at least a portion of the user-input information over a communication network 16 (e.g., LAN, WAN such as the Internet or other network using telecommunication lines, a combination thereof, etc. . . . ) to be received by, or on behalf of an insurance provider for a decision on the request for prior authorization.

In addition to the user computer 12 other, similar computers can optionally be included in the system 10. For example, an insurance provider computer 20 can be operatively connected to communicate with the user computer 12 via the communication network 16. The insurance provider computer 20, referred to generally hereinafter as the provider computer 20, can be utilized by, or on behalf of an insurance provider, or a party acting on behalf or in place of the insurance provider, to receive and/or transmit communications over the communication network 16 pertaining to a claim for at least partial coverage of a prescription drug cost. The provider computer 20 can include the same, or similar components as the user computer 12, and can optionally be programmed with computer-executable instructions for receiving requests for prior authorization and issuing a response to such requests. The provider computer 20 can be located at an office of the health insurance provider or another party authorized to act on behalf of the health insurance provider, and can be utilized by a representative of the health insurance provider or other party to contribute to the transmission of an answer to the requests for prior authorization in the instances where human involvement is required. The provider computer 20 can optionally include a facsimile card allowing the provider computer 20 to receive fax transmissions from and/or send fax transmissions to stand-alone fax machines connected to the communication network 16. According to alternate embodiments, the provider computer 20 can optionally be programmed to facilitate the transmission and/or receipt of fax transmissions, or a network-based solution including a remotely-located fax server that receives transmissions from the provider computer 20 and, in turn, transmits the fax transmission to the intended stand-alone fax machine. Fax transmissions sent to/received by the provider computer 20 according to such an embodiment are referred to herein as eFax transmissions, as the document is transmitted as a fax transmission from an electronic document without first being printed as a hardcopy that is scanned by a stand-alone facsimile machine. According to alternate embodiments, the provider computer 20 can optionally be accompanied by a stand-alone, dedicated facsimile machine to send/receive traditional fax transmissions, originating from a scanned version of a hardcopy document, over the communication network 16.

A server 22 can optionally be included as part of the system 10 to serve content used to computer terminals such as the user computer 12 and/or provider computer 20. For example, electronic forms such as those in which information is entered by the user to submit a request for prior authorization can be served over the communication network 16 by the server 22. Information entered into such forms can be transmitted over the communication network 16, optionally as part of the completed form or at least with data indicative of the field in which each quantity of information was entered (e.g., as XML, JSON, etc. . . . files) to be received by or on behalf of the insurance provider for a decision on the request for prior authorization. The server 22 can optionally be maintained by, or on behalf of a third-party intermediary that is independent of both the user and the health insurance provider.

To minimize confusion of the part of users who submit requests for prior authorization, the system 10 supports the submission of such requests according to a plurality of different protocols. A common front end, optionally accessible over the communication network 16 as a website or as a point-of-sale interface for example, can optionally be utilized by the user to complete and submit such requests, regardless of the manner in which the request is ultimately to be submitted to the insurance provider or other party acting on behalf of the insurance provider. Thus, the user can utilize a familiar front end, regardless of the manner in which the request for prior authorization is to be submitted, and the actual submission can be performed in the background, optionally invisibly to the user.

The party that is to receive the request for prior authorization can be any intended recipient to which a request for prior authorization can be submitted in the course of receiving a decision on that request. For example, the intended recipient can be the insurance provider, a pharmacy benefits manager, or any other such party. For the sake of brevity, however, the party receiving the request will be referred to hereinafter, and in the drawings, as the insurance provider.

The user can be a pharmacist or other representative of a pharmacy where a prescription was taken to be fulfilled, a physician or other person at the prescribing physician's office, or other person who is to submit a request for prior authorization using the user computer 12. For the sake of brevity, this person will be referred to hereinafter generically as the user.

In use, the system 10, or portion thereof (e.g., at least one of the user computer 12, the server 22, and the provider computer 20), is operable to present a pharmacist or other user with one or a plurality of alternate drugs as possible substitutes for a prescription drug that requires prior authorization. Examples of a system and method for requesting prior authorization can be found in U.S. Patent Application Publication No.: 2011/0257992 to Scantland et al., which is incorporated in its entirety herein by reference. At least one alternate drug presented does not require prior authorization for at least a portion of the cost of that alternate drug to be covered by a health insurance provider.

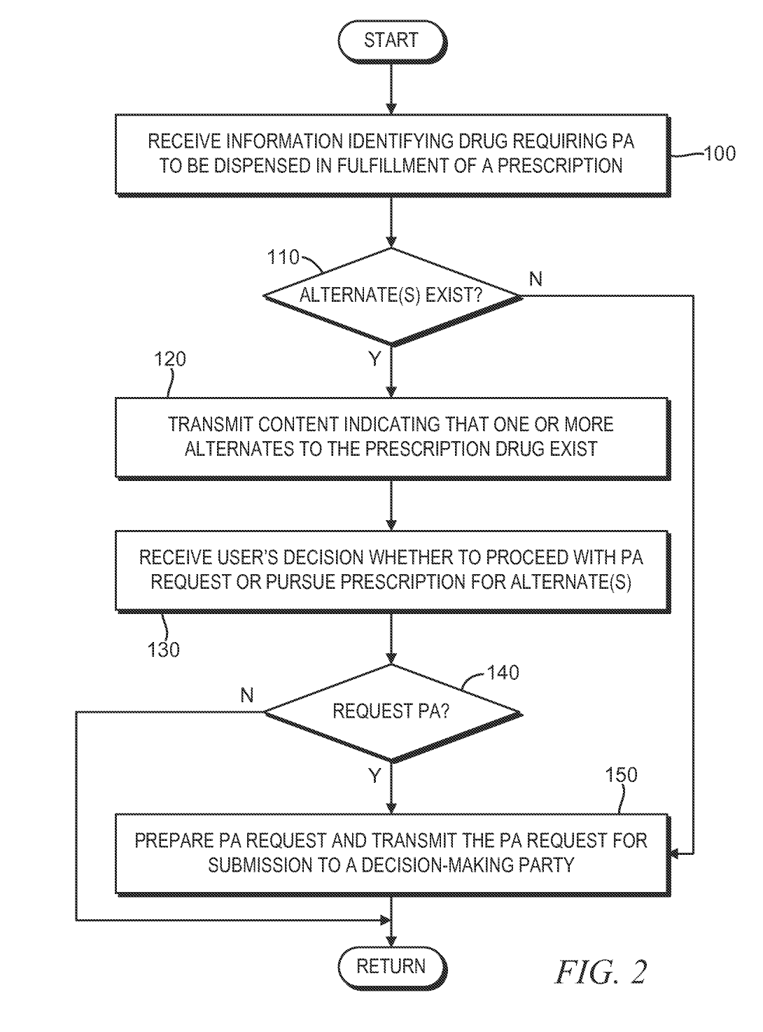

An illustrative example will be described with reference to FIGS. 2-5, in the context of a pharmacist fulfilling a prescription for a prescription drug at a pharmacy where the user computer 12 is located. Upon being presented with a prescription, the pharmacist enters information pertaining to at least one of the prescription drug and the patient into the user computer 12. This information can be transmitted over the communication network 16 to be received by a server or other computer terminal that can automatically determine whether any portion of the cost of the prescription drug is covered by the patient's insurance policy. In the event that the prescription drug is covered, the pharmacist fulfills the prescription by dispensing the prescribed quantity of the prescription drug. Any co-pay that is required by the patient's insurance policy is submitted to the pharmacy and the remainder of the costs associated with the prescription drug is covered by the insurance provider.

If, however, coverage of the prescription drug cannot automatically be determined, a result indicating that prior authorization is returned to the user computer 12. The pharmacist can then proceed with the process of requesting prior authorization in a manner such as that described in Scantland et al., which is hereby incorporated in its entirety by reference. But unlike the system described in Scantland et al., the present system, or portion thereof, can alert the pharmacist to the existence of an alternate drug suitable to be used as a substitute for the prescription drug, thereby possibly avoiding the need to request prior authorization for the prescription drug. Since the alternate drug does not require prior authorization, the need to request prior authorization at all during the transaction can possibly be avoided.

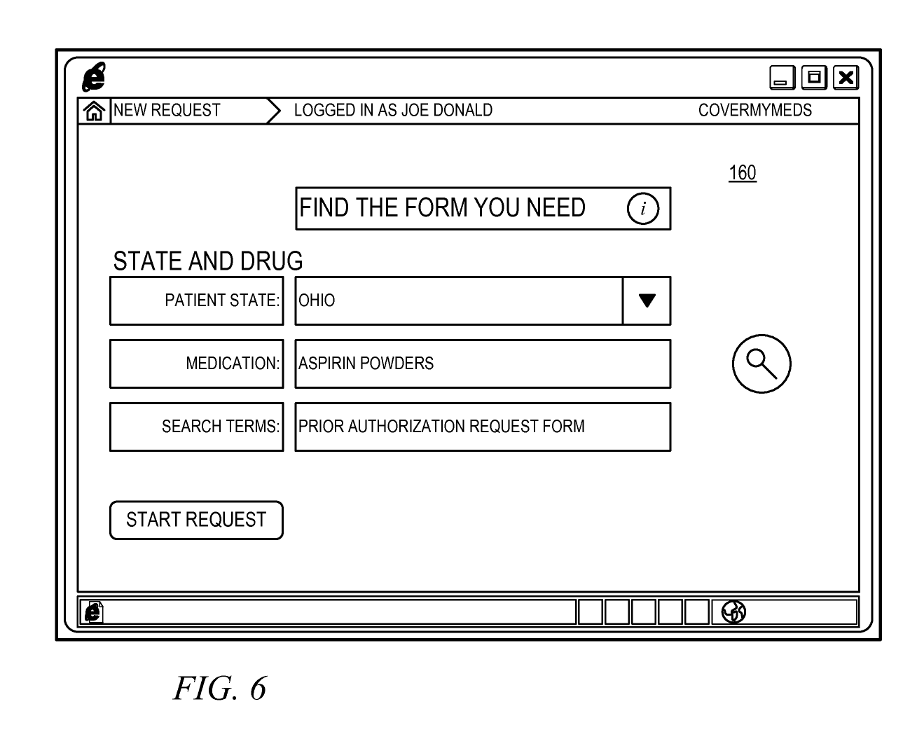

More specifically, the server 22 can receive, at step 100 of FIG. 2, information identifying at least one of the prescription drug, the state in which the patient is insured, and optionally other data concerning at least one of the patient, the prescription drug, and the patient's insurance policy. For example, FIG. 6 shows an illustrative embodiment of a user interface 160 displayed by the user computer 12 being utilized by the pharmacist, physician or other user. The user interface 160 includes fields into which the user can enter search criteria for selecting a form to be submitted over the communication network 16, for example, as part of a request for prior authorization for a prescribed drug. All or some of this information can be entered by the pharmacist via a user interface 160 to facilitate the generation of a form to be submitted for requesting prior authorization. Once the information entered into the user interface 160 has been received by the server 22, the server can determine whether an alternate drug that is a suitable substitute for the prescription drug exists at step 110. The alternate drug can be determined at step 110 to exist for any of the reasons described above (e.g., a generic is available, an alternate to the prescribed drug is present in a database of preferred drugs maintained by or on behalf of an insurance provider, the availability of the prescribed drug) or for any other reason why an alternate drug that would not require prior authorization can be substituted for a prescribed drug that does require prior authorization. If no alternate drug exists, or if a proposed alternate drug is declined or an indication that the prescribed drug is still requires is otherwise received by the server 22, the server 22 proceeds to generate the appropriate form to be submitted as a request for prior authorization at step 150 and transmits the generated form over the communication network 116. The generated form can be submitted directly to the party who is to render a decision on the request for prior authorization, or to another party such as the prescribing physician, for example, who is to supplement the information included as part of the form by the server 22 and subsequently submit the form to the party who is to render the decision.

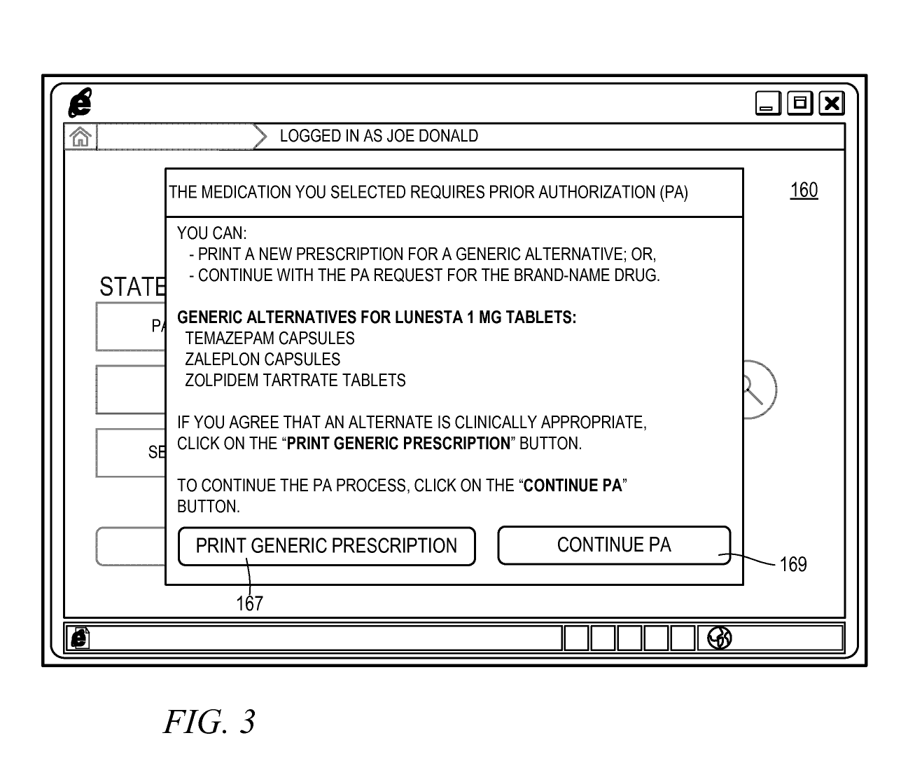

If, however, at step 110 the server 22 determines that an alternate drug does exist, the server 22 can transmit content indicating the existence of the alternate drug over the communication network to be received by the user computer 12 at step 120. With this content, the user computer 12 can optionally compare the one or more alternate drugs identified based on the communication from the server 22 to a database storing information about drugs that are currently in stock and available to be dispensed by the pharmacy. For example, the user computer 12 can utilize the information about the alternate drug transmitted by the server 22 to check the pharmacy's inventory system for that drug. The user computer 12 can also, based on the information from the server 22, display a window 165 in front of the user interface 160 as shown in FIG. 3, presenting the pharmacist with: an option 167 to print a generic prescription form to be transmitted to the physician who prescribed the prescription drug, and an option 169 to continue with the process of requesting prior authorization for the prescription drug. If, however, it is determined that none of the alternate drugs, if any, are in stock or available to be dispensed by the pharmacy the user computer 12 can optionally forgo displaying the window 165 giving the pharmacist the option to pursue a prescription for the alternate drug or proceed with a request for prior authorization. At this point, the process of preparing the form to be submitted as part of the request for prior authorization can be suspended pending a decision whether the propose alternate drug is acceptable.

The pharmacist can select either of the options 167, 169 by clicking on the desired action using a mouse or other computer input peripheral, and the selected option is received by the server 22 over the communication network 16 at step 130. If it is determined by the server 22 at step 140 that the pharmacist has elected to continue with the process of requesting prior authorization, a prior authorization form can be generated by, or based on information received from, the server 22 at step 150. Similar to the discussion above, this form can be transmitted over the communication network 116 directly to the party who is to decide whether to grant prior authorization, or to another party such as the prescribing physician, for example, who is to supplement the information in the form and subsequently submit the form to the party who is to render the decision.

If, on the other hand, it is determined at step 140 that the pharmacist has elected the option 167 to generate an ad hoc prescription for one or more of the alternate drugs, the server 22 can conclude the prior authorization request process. The server 22 can conclude the process at this point because the user computer 12 can be programmed or otherwise adapted to generate the ad hoc prescription for the one or more alternate drugs without additional input from the server 22. According to alternate embodiments, however, in response to the determination at step 140 that the pharmacist has selected the option 167 to seek a prescription for the one or more alternate drugs, the server 22 can optionally transmit content over the communication network 16 that can be used by the user computer 12 to generate the ad hoc prescription form. But regardless of whether the server 22 and/or the user computer 12 generates the ad hoc prescription form for the alternate drug(s), this ad hoc prescription form can be transmitted over the communication network 16 to the physician who prescribed the prescription drug in the first place for approval. For example, the ad hoc prescription form can be printed locally by the pharmacist using the user computer 12 and subsequently transmitted via a facsimile transmission to the prescribing physician. According to alternate embodiments, the ad hoc prescription form for the alternate drug(s) can be transmitted over the communication network 16 as an electronic fax (a.k.a., efax) from the user computer 12 without first printing a hard copy of the ad hoc prescription form. According to another embodiment, the ad hoc prescription form can be saved locally by the user computer 12, or otherwise made available to the user computer 12, to be attached to an e-mail address to the prescribing physician. According to yet another embodiment, the ad hoc prescription form for the one or more alternate drugs can be submitted to the prescribing physician through an account established at a third-party service provider that facilitates and at least partially automates requests for prior authorization such as CoverMyMeds. According to such an embodiment, once the ad hoc prescription form is made accessible to the prescribing physician, the prescribing physician can be alerted via a notification sent through e-mail or otherwise conveyed through the third-party service provider. The prescribing physician can then log into his/her user account to access the ad hoc prescription form and execute this form to be submitted once again to the pharmacy for fulfillment instead of the original prescription for the prescription drug that required prior authorization.

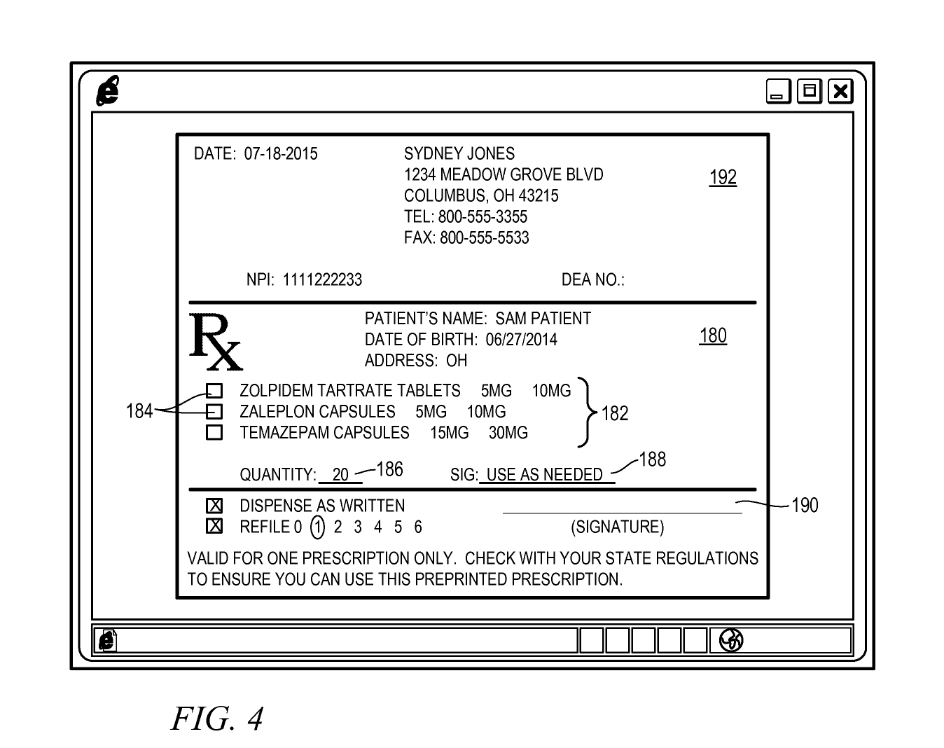

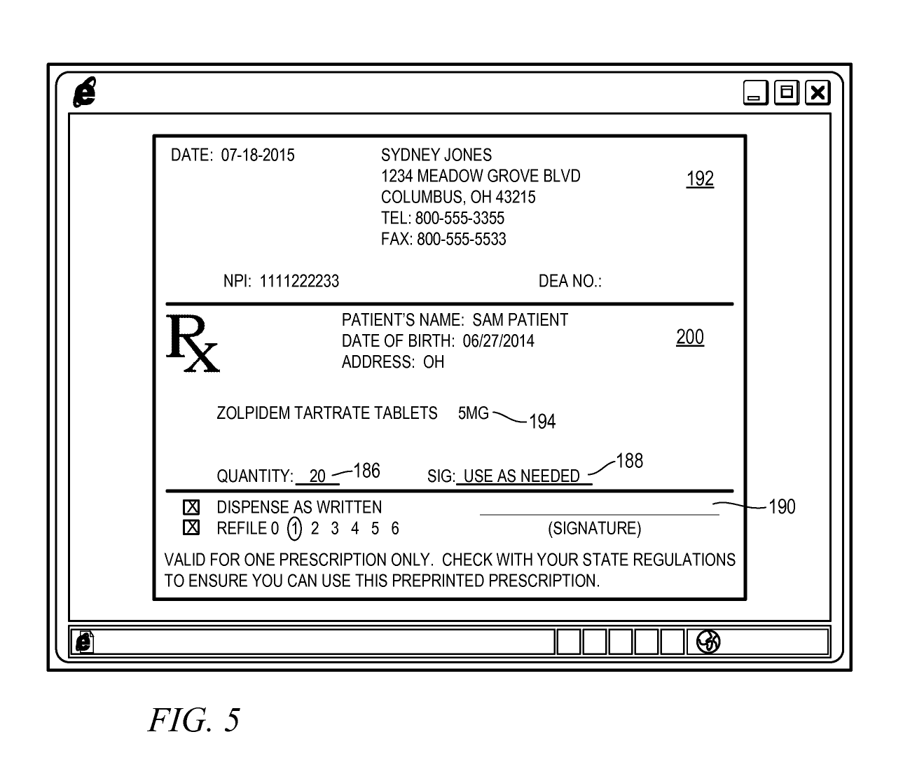

Although the example described above involves a pharmacist initiating the prior authorization request process, alternate embodiments can involve a prescribing physician (or a representative authorized to participate in the prior authorization request process on behalf of the physician) initiating that process via the user interface 160 of the website instead of the pharmacist. Generally, the method is similar to that described above, except the physician/authorized representative (hereinafter generically referred to as they “prescriber”) enters the relevant information and is presented with the options 167, 169 shown in FIG. 3. If the prescriber selects option 167, to generate the ad hoc prescription form, the prescriber can also optionally be presented with a listing that includes one or a plurality of alternate drugs, if they exist. If more than one alternate drug is presented to the prescriber, the prescriber can select the desired alternate drug since the prescriber is licensed to prescribe prescription drugs to patients. If the pharmacist is presented with more than one alternate drug option, each of the existing options must be conveyed to the prescriber by the pharmacist as an additional step so the prescriber can select and authorize a prescription for the desired alternate drug. An example of the different ad hoc prescription forms for each of these scenarios is discussed below with reference to FIGS. 4 and 5.

An example of the ad hoc prescription form 180 prepared for a pharmacist is shown in FIG. 4. According to this illustrative embodiment, the ad hoc prescription form 180 includes the contact information 192 of the prescribing physician to whom the ad hoc prescription form 180 is to be conveyed for authorization. Thus, the ad hoc prescription form 180 can be conveyed to the prescribing physician by the pharmacist utilizing the fax number, for example, included amongst the contact information 192, without requiring the pharmacist to search out this information. Since the pharmacist cannot select the alternate drug from the available options, a listing 182 is also included on the ad hoc prescription form 180, and includes each of a plurality of alternate drugs that have been determined to exist. Each entry in the listing 182 includes at least one of the form (e.g., capsule, tablet, etc. . . . ) of the alternate drug, a dose of the alternate drug, and any other information pertaining to the alternate drug that must be specified by the prescribing physician in a valid prescription. A checkbox 184 can be checked by the prescriber to whom the ad hoc prescription form 180 is conveyed to identify the appropriate alternate drug that is to be substituted for the prescription drug, and a quantity field 186 indicates the amount of the selected alternate drug to be dispensed. A free-form text entry line 188 allows the prescribing physician to freely enter any additional remarks, as appropriate. The prescriber can then sign the completed ad hoc prescription form in the signature field 190 and submit the signed ad hoc prescription form to the pharmacy to be fulfilled. The prescriber can optionally utilize an electronic signature in the signature field 190 and submit the completed ad hoc prescription form to the pharmacy electronically via e-mail, facsimile, or the like. Because the alternate drug(s) appearing on the ad hoc prescription form 180 has/have already been identified as not requiring prior authorization, the need to obtain prior authorization to fulfill a prescription can possibly be avoided.

FIG. 5 shows an alternate embodiment of an ad hoc prescription form 200 that is prepared by a prescriber who has initiated the process for requesting prior authorization and selected option 167 in FIG. 3. According to the present embodiment, instead of the listing 182 including a plurality of individual alternate drugs that are suitable substitutes, a single alternate drug 194 selected by the prescriber appears on the ad hoc prescription form 200. Since the prescriber is licensed to select the alternate drug to be prescribed, the pharmacist can optionally be presented with a menu (e.g., a drop down menu, check boxes, etc. . . . ) that allows the pharmacist to select the alternate drug that is to appear on the completed ad hoc prescription form 200.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

1. A method of processing a request pertaining to a prescription drug, the method comprising, with a suitably-programmed computer system:
receiving, after a claim requesting at least partial insurance coverage of a cost associated with the prescription drug has been submitted to an insurance benefits manager, a notification that prior authorization of the at least partial insurance coverage has been required by the insurance benefits manager;
receiving information identifying the prescription drug for which a request for prior authorization of the at least partial insurance coverage under an insurance policy is to be submitted;
before submitting the request for prior authorization and after receiving the notification indicating that prior authorization has been required, determining that an alternate drug is a possible substitute for the prescription drug, but is believed to not require prior authorization under the insurance policy, based on data contained in a database that is accessible to the computer system, wherein said data is generally accepted in a pharmacy industry and is not unique to an insurer affiliated with the insurance policy;
without first submitting the request for prior authorization to the insurance benefits manager, transmitting content over the communication network to indicate that the alternate drug exists;
determining whether the alternate drug is to be substituted for the prescription drug; and
in response to receiving an indication that the alternate drug is to be substituted, suspending a process of requesting prior authorization for the prescription drug without submitting the request for prior authorization to the insurance benefits manager.

2. The method of claim 1, wherein the information identifying the prescription drug is transmitted over a communication network by a pharmacy computer terminal utilized by a pharmacy during fulfillment of a prescription for the prescription drug as part of the request for prior authorization.

3. The method of claim 1, wherein the information identifying the prescription drug is transmitted over a communication network by a user computer terminal utilized by a prescriber issuing a prescription for the prescription drug.

4. The method of claim 1, wherein said determining that the alternate drug can be offered as the substitute comprises:
identifying the alternate drug based on an association with the prescription drug in the database, and
determining that the alternate drug is in stock at a pharmacy where a prescription for the prescription drug is to be fulfilled and is available to be immediately dispensed without submitting the request prior authorization.

5. The method of claim 1, wherein said determining that the alternate drug is available comprises at least one of:
determining that a generic equivalent to the prescription drug exists; and
determining that a less-expensive, therapeutically-similar substitute for the prescription drug exists.

6. The method of claim 1, wherein the database that is not unique to the insurer comprises a collection of data that is accepted as true, but has not been independently verified by the insurer or any other insurer, as a dedicated verification transaction separate from a transaction during which prior authorization is requested, as being true.

7. The method of claim 6 further comprising updating the database to indicate that a portion of the data has been verified in response to approval by the insurance benefits manager of at least partial insurance coverage of the alternate drug without requiring prior authorization.

8. The method of claim 1, wherein the database comprises a plurality of alternates accepted as being suitable substitutes for a plurality of different prescription drugs under insurance policies of different insurers.

9. The method of claim 1, wherein the data is not unique to the insurance policy.

10. The method of claim 1 further comprising:
terminating the process of requesting prior authorization in response to receiving an indication that a prescription for the prescription drug was fulfilled with the alternate drug.

11. The method of claim 1 further comprising:
in response to receiving an indication that the prescription drug is desired, resuming the process of requesting prior authorization by transmitting content as part of the request for prior authorization over the communication network to be submitted to the insurance benefits manager.

12. The method of claim 1, wherein said determining that the alternate drug is a possible substitute for the prescription drug and submitting the claim requesting at least partial insurance coverage of the cost associated with the prescription drug are performed by different parties.
